(19) United States
(12) Patent Application Publication
(10) Pub. No.: US 2024/0261807 A1
(43) Pub. Date: Aug. 8, 2024

(54) ELECTROSTATIC ATOMIZER

(71) Applicant: Carlisle Fluid Technologies, INC., Scottsdale, AZ (US)

(72) Inventors: Benjamin Szirony, Toledo, OH (US); Alex Wolf, Toledo, OH (US); James Baltz, Perrysburg, OH (US); David Seitz, Riga, MI (US); Rodney Nichols, Orland, IN (US)

(21) Appl. No.: 18/567,219

(22) PCT Filed: Jun. 9, 2021
(86) PCT No.: PCT/US2021/036576

§ 371 Date: Dec. 5, 2023

(51) Int. Cl. B05B 5/025; B05B 3/10; B05B 15/55

(52) U.S. Cl. CPC B05B 5/025; B05B 3/10; B05B 15/55

(57) ABSTRACT

An electrostatic atomizer can include an applicator rotatably attached to a distal end of a turbine and a shaft; and an applicator washing component comprising a solvent fluid line configured to separately dispense a cleaning solvent to an external applicator surface by an external solvent line and an internal applicator surface by an internal solvent line, wherein the cup washing component is distinct from a coating fluid line.

### BACKGROUND

The subject disclosure relates to electrostatic atomizer, and more specifically to an electrostatic atomizer that can include an applicator rotatably attached to a distal end of a turbine and a shaft; and an applicator washing component comprising a solvent fluid line configured to separately dispense a cleaning solvent to an external applicator surface by an external solvent line and an internal applicator surface by an internal solvent line, wherein the cup washing component is distinct from a coating fluid line.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later.

In one or more embodiments, provided are devices, systems, computer-implemented methods and/or computer program products that facilitate electrostatic atomization. In an embodiment, provided is an electrostatic atomizer comprising: an applicator rotatably attached to a distal end of a turbine and a shaft; and an applicator washing component comprising a solvent fluid line configured to separately dispense a cleaning solvent to an external applicator surface by an external solvent line and an internal applicator surface by an internal solvent line, wherein the cup washing component is distinct from a coating fluid line. In an embodiment, provided is an electrostatic atomizer wherein the solvent source is configured to clean the applicator by diverging to an internal solvent line and an external solvent line. In an embodiment, provided is the electrostatic atomizer wherein the external solvent line passes through an external solvent line cavity in the fluid tip, wherein the external solvent line cavity is upstream of the mounting member.

### BRIEF DESCRIPTION OF THE DRAWINGS

FIG. 1 illustrates an example, non-limiting electrostatic atomizer of the embodiments disclosed herein.

FIG. 2 illustrates an example, non-limiting illustration of the cup wash system disclosed herein.

FIG. 3 illustrates an example, non-limiting electrostatic atomizer of the embodiments disclosed herein.

FIG. 4 illustrates an example, non-limiting electrostatic atomizer of the embodiments disclosed herein.

FIG. 5 illustrates an example, non-limiting fluid tip of the embodiments disclosed herein.

FIG. 6 illustrates an example, non-limiting bell cup applicator of the embodiments disclosed herein.

FIG. 7 illustrates an example, non-limiting splash plate system of the embodiments disclosed herein.

FIG. 8 illustrates an example, non-limiting coiled tube of the embodiments disclosed herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

An electrostatic atomizer can include an air motor, wherein the air motor comprises a turbine. The output shaft of the air motor can be connected to the applicator at a distal end and thereby the applicator can be driven to rotate with the rotary power from the air motor. The air motor can be housed in an air motor housing. The air motor housing can include a turbine air supply path, turbine air exhaust path, and bearing air supply path for a bearing that supports the output shaft of the air motor in a floating condition.

The electrostatic atomizer can include a shroud circumscribing a main body and an air turbine provided in the body. The applicator can be a rotary atomizing bell cup operatively connected to air turbine for rotation thereby and the resultant atomization of coating materials supplied thereto. The turbine can receive a supply of pressurized air through a pressurized air line communicating with an air connector in a robot adaptor and supplied with pressurized air from a robot, painting station, or combination thereof. Additional pressurized air lines can be provided to various outlets in the shroud to provide shaping air to control and refine the pattern of atomized coating material from the atomizing bell cup.

The atomized coating can be charged with electrical potential and to ground the object being coated so that the coating material is attracted to the object, thereby reducing overspray and improving coverage on irregularly shaped target objects. In certain embodiments, an electrostatic atomizer can comprise an applicator rotatably attached to a distal end of a turbine and shaft; and an applicator washing component comprising a solvent fluid line configured to separately dispense a cleaning solvent to an external applicator surface by an external solvent line and an internal applicator surface by an internal solvent line, wherein the cup washing component is distinct from a coating fluid line.

In some embodiments, a solvent line can enter a fluid tip through a fluid tube. The solvent line can split into internal cup wash, which can run out of a front of a bell cup and clean a bell cup inner surface, and an external cup wash which can diverse into a groove in the applicator and is thereby directed to an external surface of a bell up, thereby cleaning the external surface of the applicator.

According to multiple embodiments, the electrostatic atomizer can be configured such that the external solvent line diverges from the solvent fluid line upstream of a mounting member. In some embodiments, the electrostatic atomizer can be configured such that the external solvent line diverges from the solvent fluid line within a fluid tip. According to multiple embodiments, the electrostatic atomizer can be configured such that the external solvent line diverges to a plurality of external cup wash outlets, wherein the plurality of external cup wash outlets are radially evenly spaced about a fluid tip center axis.

An advantage of the fluid tip of the present embodiments can be the diversity of solvent ports. Prior art fluid tips can distribute solvent out of a single stream from a circular hole in the top of a fluid tip to clean an internal applicator surface. The present embodiments can have a plurality of components, providing an anulus which can have a plurality of holes for distributing solvent evenly in a substantially circular form about the fluid tip center axis for internal cup wash. The solvent line of the fluid tip can be split into an internal cup wash and an external cup wash. The external cup wash can split into two lines of 40 degrees to 50 degrees relative to the fluid tip center axis, which can be 45 degrees each and symmetric about the fluid tip center axis. The lines can distribute solvent evenly to a groove of the applicator that can be used for external cup washing.

In certain embodiments, the electrostatic atomizer can be configured such that the plurality of external cup wash outlets are at between a 40 degree and a 50 degree angle relative to the fluid tip center axis. In some embodiments, the electrostatic atomizer can be configured such that the fluid tip further comprises a fluid tip insert component radially circumscribing the external cup wash outlets and wherein the fluid tip insert component is configured to fit into a splash plate.

In certain embodiments, the electrostatic atomizer can be configured such that the applicator is a bell cup, wherein the bell cup comprises: an external cup wash groove circumscribing the bell cup around a cup base; an internal cup wash groove circumscribing a bell cup center axis axially behind the cup base; and a bell cup threaded surface axially between the external cup wash groove and internal cup wash groove.

In some embodiments, the applicator can be a bell cup and the bell cup can be approximately 65 millimeters in diameter. The bell cup can have a threaded surface for inserting a splash plate and be configured to distribute external cup wash from a bell cup instead of a separate fluid nozzle. The bell cup can include a groove that is positioned proportionally to the placement of a plurality, which can be two, 40 degree to 50 degree holes of the external cup wash in the fluid tip. These grooves can be rounded to promote fluid movement and gathering about the curves and exiting the cup by a plurality, which can be ten, evenly radially spaced angled passages or applicator holes extending from the internal cup wash groove. The holes can be positioned toward a back of the bell cup to provide a fluid stream interruption, which can slow the fluid and thereby allow it to collect in an even coating of solvent to run along the external edge of the bell cup. The grooves nearest these holes can aid the process of gathering the fluid evenly.

In some embodiments, the electrostatic atomizer can be configured such that the bell cup further comprises a splash plate hardstop axially between the bell cup threaded surface and external cup wash groove. According to multiple embodiments, the electrostatic atomizer can be configured such that the bell cup threaded surface and splash plate hardstop are radially centered about a bell cup center axis. In some embodiments, the electrostatic atomizer of can further include a splash plate system, wherein the splash plate system comprises: a splash plate base; and a splash plate comprising a plurality of splash plate holes radially evenly spaced about a splash plate center axis.

In certain embodiments, the electrostatic atomizer can be configured such that the splash plate base comprises a splash plate threaded portion configured to threadedly connect to a bell cup bell cup threaded surface.

In some embodiments, the electrostatic atomizer can be configured such that the splash plate base comprises a splash plate base protrusion configured to fit within a splash plate notch, and wherein the splash plate base is fixed to the splash plate by a plurality of pins.

In some embodiments, the electrostatic atomizer can further include a shaping air system for a coating atomizer, wherein the shaping air system comprises: a shroud, wherein the shroud comprises a plurality of concentric rings of holes, wherein a first concentric ring is configured to direct shaping air toward an edge of an applicator, and wherein a second concentric ring is configured to direct shaping air away from the edge of the applicator, and wherein the plurality of concentric rings are configured to generate a shaping air spin against a direction of rotation of the applicator.

A shaping air shroud can manipulate and force pressurize air through a plurality of holes, which can be a plurality of concentric rings of holes, within the shaping air system. The plurality of concentric rings of holes can be uniplanar. The plurality of concentric rings of holes can be two sets of circumferential patters evenly radially distributed about a center axis. An inner concentric ring of holes can be between 2.6 and 2.9, and in some embodiments, between 2.7 and 2.8, and in some embodiments, between 2.78 and 2.79 inches in diameter and have 40 holes. In some embodiments, an outer concentric ring of holes can be between 2.9 and 3.1 inches in diameter, and in some embodiments, 3 inches in diameter, and have 40 holes. The inner concentric ring of holes can be angled such that the air spins against the rotation of the applicator. The inner concentric ring of holes can be angled toward an edge of the applicator, and thereby control paint particles closer to the center axis. In some embodiments, an outer concentric ring of holes can be angled away from the top edge of the applicator to control paint particles farther away from the center axis. Paint can be dispersed along a concave surface of the applicator and is thereby atomized into small particles into the air using a centrifugal force of rotation.

In some prior art embodiments, an applicator of substantially conical shape promotes the creation of vortices of turbulence, low pressure/turbulent regions, beneath and/or behind the applicator. This can result in paint being sucked back in an upstream direction, and lead to messes and waste. An advantage of the present embodiments can be that the inner concentric ring of holes, by directing air toward the edge of the applicator, limits the size of these turbulent regions. To further reduce the creation of low pressure regions, lower shaping air component can limit the relative energy from the turbulent regions, and thereby limit transient negative pressure gradients underneath or beneath an outer surface of the applicator, specifically, in a region near and behind/underneath the applicator edge. The flat surface of lower shaping air component limits the region of turbulence between the inner concentric ring of holes and a rounded top outer surface of the applicator. Turbulent kinetic energy can be limited by the present of a wall angled along a smooth edge of the applicator and a parallel surface of lower shaping air component. This can reduce the Reynold's Number of the fluid, thereby limiting energy due to turbulence.

According to multiple embodiments, the electrostatic atomizer can further include a lower shaping air component, wherein the lower shaping air component is configured to limit negative pressure region sizes behind the applicator, wherein the lower shaping air component comprises a smooth inner surface substantially parallel to an inner surface of the applicator.

In some embodiments, the electrostatic atomizer can include a high voltage supply; a grounded robot manifold plate; and a coiled tube, wherein the coiled tube segregates the high voltage supply from the robot manifold plate, wherein the coiled tube is in fluid communication with a solvent source.

A coiled tube of some of the present embodiments can be an advantage when working with a water-based paint and is compatible with a solvent based paint. In some prior art embodiments, charged paint can collect within a paint line and arc to a grounded robot manifold plate. The coiled tube can lengthen the distance between paint in the line and the grounded plate, as well as compel the paint to collect at the lowest point in each portion of the coil. Separating the charged paint into the lowest points in different portions of coil prevents a contiguous path to ground for the charged paint and prevents the more concentrated collection of charged paint, thereby preventing a greater concentration of charge.

The coiled tube of some of the present embodiments can provide for a high di-electric protection by comprising or consisting of a perfluoroalkoxy alkane (PFA) tubing inside a nylon sleeve. The coiled tube can be made by inserting the PFA tubing inside the nylon sleeve, wrapping on a mandrel, and heating to just below a melting point to form the tube into shape. The coiled tube can be installed by wrapping it around a paint inlet isolation tube, which can be charged. This prevents a voltage difference between the coiled tube and the paint inlet isolation tube, which prevents arcing with can lead to pin holes in the coil or isolation tube.

In some embodiments, the electrostatic atomizer can be configured such that the solvent source is configured to clean the applicator by diverging to an internal solvent line and an external solvent line. In certain embodiments, the electrostatic atomizer can further include a paint inlet isolation tube, wherein the coiled tube is wrapped around the paint inlet isolation tube. In some embodiments, the electrostatic atomizer can be configured such that the coiled tube comprises a perfluoroalkoxy alkane polymer.

According to multiple embodiments, the electrostatic can be configured such that the coiled tube consists of a perfluoroalkoxy alkane polymer within an outer nylon tube.

In certain embodiments, the electrostatic atomizer can be configured such that the external solvent line passes through an external solvent line cavity in the fluid tip, wherein the external solvent line cavity is upstream of the mounting member.

In some embodiments, the electrostatic atomizer can be configured such that the applicator comprises an applicator cavity. According to multiple embodiments, the electrostatic atomizer can be configured such that the applicator comprises a plurality of applicator holes. In some embodiments, the electrostatic atomizer can be configured such that the external solvent line is configured to feed cleaning solvent into the applicator cavity. In certain embodiments, the electrostatic atomizer can be configured such that the cleaning solvent is configured to move from the applicator cavity to the external surface of the applicator through the plurality of holes.

In some embodiments, the electrostatic atomizer of can be configured such that the internal solvent line diverges from the solvent fluid line downstream of a mounting member. According to multiple embodiments, the electrostatic atomizer can be configured such that the applicator is a bell cup comprising a splash plate. In some embodiments, the electrostatic atomizer can be configured such that the fluid path deflector comprises a splash plate inner surface and splash plate outer surface. In certain embodiments, the electrostatic atomizer can be configured such that the internal solvent line is configured to dispense cleaning solvent upstream and downstream of the fluid path deflector inner surface.

According to multiple embodiments, the electrostatic atomizer can be configured such that cleaning solvent from the internal solvent line is configured to pass over the internal applicator surface, the fluid path deflector inner surface, and the fluid path deflector outer surface by rotary motion of the bell cup. According to multiple embodiments, a method of cleaning an applicator of an electrostatic atomizer, can comprise providing the electrostatic atomizer of the embodiments herein; and passing cleaning solvent through the cup washing component.

In some embodiments, the electrostatic atomizer can include a shaping air shroud, wherein the smooth inner surface is adjacent to an expansion area, wherein the expansion area is configured to reduce a Reynold's Number of an air flow around the edge of the applicator.

In some embodiments, the electrostatic atomizer can include a shaping air shroud, wherein the expansion area is partially defined by a flat front wall of the atomizer shroud. In certain embodiments, the electrostatic atomizer can include a shaping air shroud, wherein the expansion area is partially defined by an angled edge of the applicator. In some embodiments, the electrostatic atomizer can include a shaping air shroud, wherein the expansion area is partially defined by a lower extension wall of the atomizer shroud. According to multiple embodiments, the electrostatic atomizer can include a shaping air shroud, wherein the lower extension wall is adjacent to the flat front wall. In certain embodiments, an electrostatic atomizer can be configured such that a fluid tip further includes a fluid tip insert component radially circumscribing the external cup wash outlets and wherein the fluid tip insert component is configured to fit into a splash plate.

In some embodiments, an electrostatic atomizer can be configured such that the fluid tip includes a notched surface, wherein the fluid tip external cup wash outlets are configured to deliver solvent through a portion of the notched surface. According to multiple embodiments, the electrostatic atomizer can be configured such that the bell cup threaded surface is configured to receive and secure a splash plate by a threaded connection. In certain embodiments, the electrostatic atomizer can be configured such that wherein the external cup wash groove is configured to receive solvent from a plurality of external cup wash outlets. In some embodiments, the electrostatic atomizer can be configured such that a plurality of holes exit the splash plate at an angle between 40 and 50 degrees relative to a splash plate center axis.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

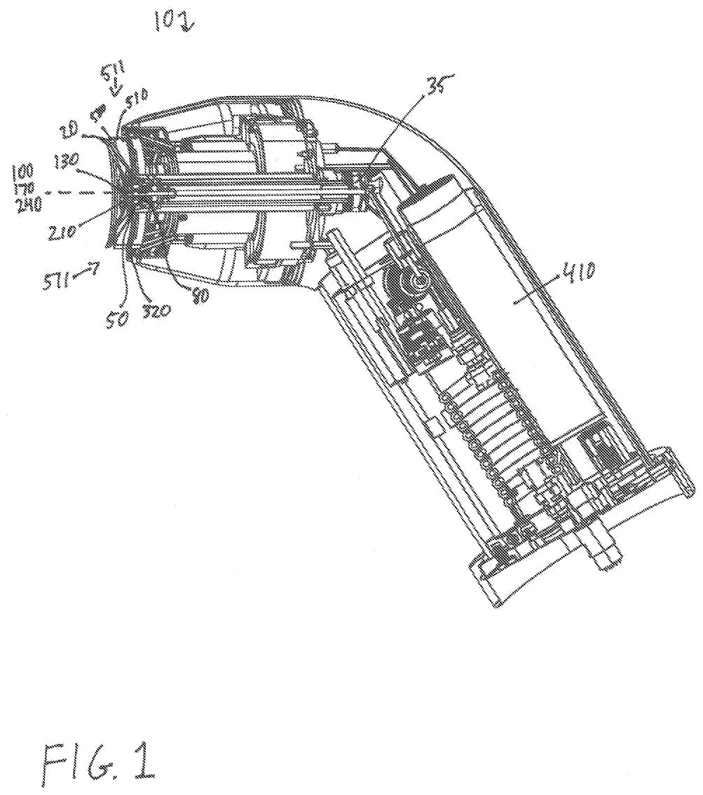

FIGS. 1-8 illustrate an example, non-limiting electrostatic atomizer 10 of the embodiments disclosed herein. As shown in FIG. 1, an electrostatic atomizer 10 can include an air motor, wherein the air motor comprises a turbine. The output shaft of the air motor can be connected to the applicator at a distal end and thereby the applicator 20 can be driven to rotate with the rotary power from the air motor. The air motor can be housed in an air motor housing. The air motor housing can include a turbine air supply path, turbine air exhaust path, and bearing air supply path for a bearing that supports the output shaft of the air motor in a floating condition.

The electrostatic atomizer 10 can include a shroud circumscribing a main body and an air turbine provided in the body. The applicator can be a rotary atomizing bell cup 20 operatively connected to air turbine for rotation thereby and the resultant atomization of coating materials supplied thereto. The turbine can receive a supply of pressurized air through a pressurized air line communicating with an air connector in a robot adaptor and supplied with pressurized air from a robot, painting station, or combination thereof. Additional pressurized air lines can be provided to various outlets in the shroud to provide shaping air to control and refine the pattern of atomized coating material from the atomizing bell cup 20.

The atomized coating can be charged with electrical potential and to ground the object being coated so that the coating material is attracted to the object, thereby reducing overspray and improving coverage on irregularly shaped target objects.

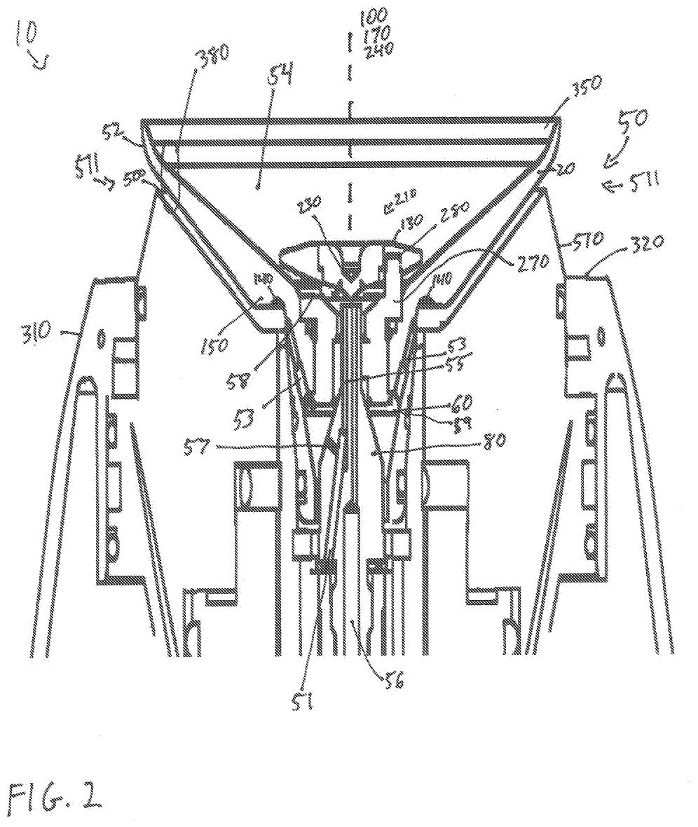

As shown in FIG. 2, in certain embodiments, an electrostatic atomizer 10 can comprise an applicator 20 rotatably attached to a distal end of a turbine and shaft 35; and an applicator washing component 50 comprising a solvent fluid line 51 configured to separately dispense a cleaning solvent to an external applicator surface 52 by an external solvent line 53 and an internal applicator surface 54 by an internal solvent line 55, wherein the cup washing component 50 is distinct from a coating fluid line 56.

According to multiple embodiments, the electrostatic atomizer 10 can be configured such that the external solvent line 53 diverges from the solvent fluid line 51 upstream of a mounting member 60.

In some embodiments, the electrostatic atomizer 10 can be configured such that the external solvent line 53 diverges from the solvent fluid line 51 within a fluid tip 80.

According to multiple embodiments, the electrostatic atomizer 10 can be configured such that the external solvent line 53 diverges to a plurality of external cup wash outlets 90, wherein the plurality of external cup wash outlets 90 are radially evenly spaced about a fluid tip center axis 100.

In certain embodiments, the electrostatic atomizer 10 can be configured such that the plurality of external cup wash outlets 90 are at between a 40 degree and a 50 degree angle 110 relative to the fluid tip center axis 100.

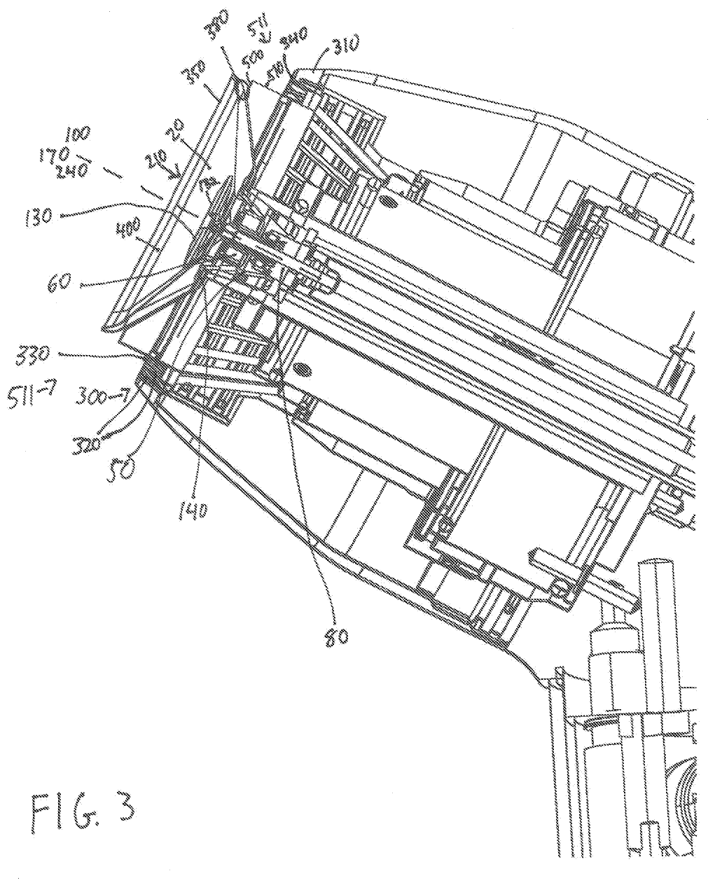

As shown in FIG. 3, in some embodiments, the electrostatic atomizer 10 can be configured such that the fluid tip 80 further comprises a fluid tip insert component 120 radially circumscribing the external cup wash outlets 90 and wherein the fluid tip insert component 120 is configured to fit into a splash plate 130 and fluid tip base 512.

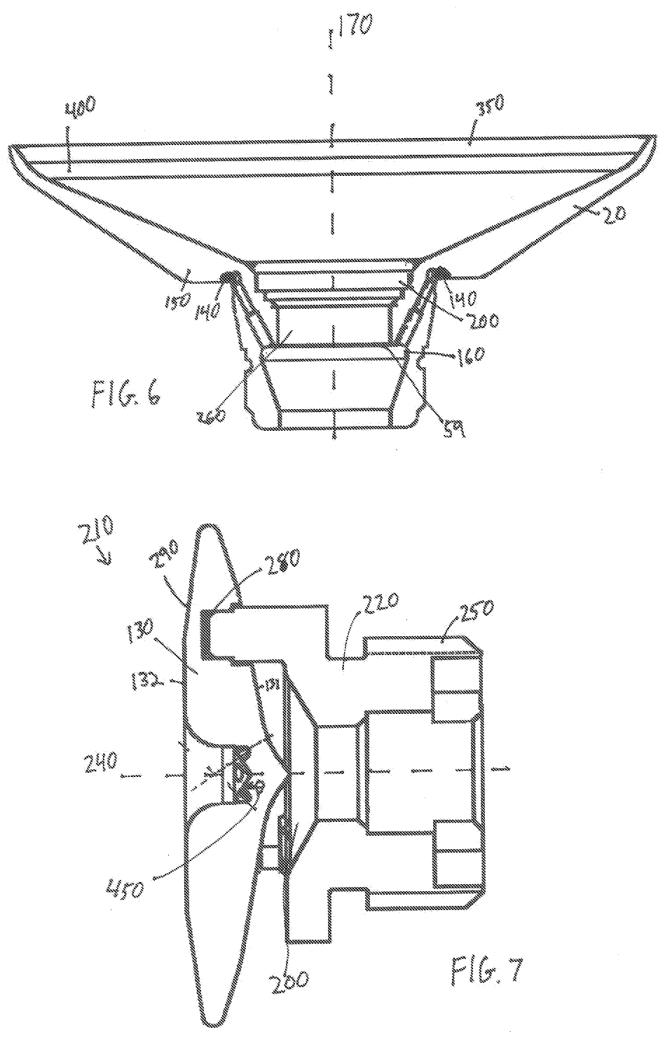

As sown in FIG. 6, in certain embodiments, the electrostatic atomizer 10 can be configured such that the applicator 20 is a bell cup 20, wherein the bell cup 20 comprises: an external cup wash groove 140 circumscribing the bell cup 20 around a cup base 150; an internal cup wash groove 160 circumscribing a bell cup center axis 170 axially behind the cup base 150; and a bell cup 20 threaded surface 260 axially between the external cup wash groove 140 and internal cup wash groove 160.

In some embodiments, the electrostatic atomizer 10 can be configured such that the bell cup 20 further comprises a splash plate hardstop 200 axially between the bell cup 20 threaded surface 260 and external cup wash groove 140.

According to multiple embodiments, the electrostatic atomizer 10 can be configured such that the bell cup 20 threaded surface 260 and splash plate hardstop 200 are radially centered about a bell cup center axis 170.

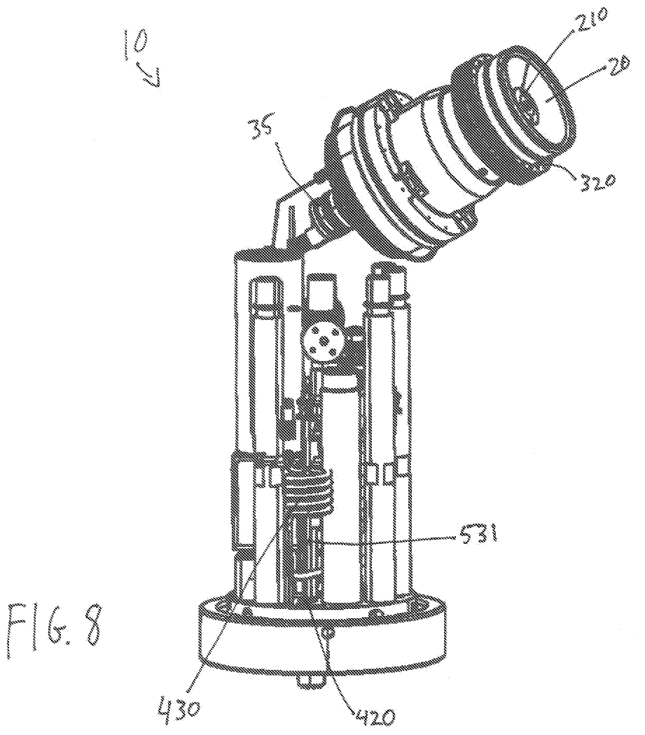

As shown in FIG. 7, in some embodiments, the electrostatic atomizer 10 of can further include a splash plate system 210, wherein the splash plate system 210 comprises: a splash plate base 220; and a splash plate 130 comprising a plurality of splash plate holes 230 radially evenly spaced about a splash plate center axis 240.

In certain embodiments, the electrostatic atomizer 10 can be configured such that the splash plate base 220 comprises a splash plate threaded portion 250 configured to threadedly connect to a bell cup 20 bell cup 20 threaded surface 260.

In some embodiments, the electrostatic atomizer 10 can be configured such that the splash plate base 220 comprises a splash plate base protrusion 270 configured to fit within a splash plate notch 280, and wherein the splash plate base 220 is fixed to the splash plate 130 by a plurality of pins 290.

In some embodiments, the electrostatic atomizer 10 can further include a shaping air system 300 for a coating atomizer, wherein the shaping air system 300 comprises: a shroud, wherein the shroud comprises a plurality of concentric rings of holes 320, wherein a first concentric ring 330 is configured to direct shaping air toward an edge of an applicator 20, and wherein a second concentric ring 340 is configured to direct shaping air away from the edge of the applicator 20, and wherein the plurality of concentric rings are configured to generate a shaping air spin 360 against a direction of rotation 370 of the applicator 20.

According to multiple embodiments, the electrostatic atomizer 10 can further include a lower shaping air component 380, wherein the lower shaping air component 380 is configured to limit negative pressure region sizes behind the applicator 20, wherein the lower shaping air component 380 comprises a smooth inner surface 400 substantially parallel to an inner surface of the applicator 20.

In some embodiments, the electrostatic atomizer 10 can include a high voltage supply 410; a grounded robot manifold plate 420; and a coiled tube 430, wherein the coiled tube 430 segregates the high voltage supply 410 from the robot manifold plate, wherein the coiled tube 430 is in fluid communication with a solvent source.

In some embodiments, the electrostatic atomizer 10 can be configured such that the solvent source is configured to clean the applicator 20 by diverging to an internal solvent line 55 and an external solvent line 53.

In certain embodiments, the electrostatic atomizer 10 can further include a paint inlet isolation tube 531, wherein the coiled tube 430 is wrapped around the paint inlet isolation tube 531.

In some embodiments, the electrostatic atomizer 10 can be configured such that the coiled tube 430 comprises a perfluoroalkoxy alkane polymer.

According to multiple embodiments, the electrostatic can be configured such that the coiled tube 430 consists of a perfluoroalkoxy alkane polymer within an outer nylon tube.

In certain embodiments, the electrostatic atomizer 10 can be configured such that the external solvent line 53 passes through an external solvent line cavity 57 in the fluid tip 80, wherein the external solvent line cavity 57 is upstream of the mounting member 60.

In some embodiments, the electrostatic atomizer 10 can be configured such that the applicator 20 comprises an applicator cavity 58.

According to multiple embodiments, the electrostatic atomizer 10 can be configured such that the applicator 20 comprises a plurality of applicator holes 59.

In some embodiments, the electrostatic atomizer 10 can be configured such that the external solvent line 53 is configured to feed cleaning solvent into the applicator cavity 58.

In certain embodiments, the electrostatic atomizer 10 can be configured such that the cleaning solvent is configured to move from the applicator cavity 58 to the external surface of the applicator 20 through the plurality of holes.

In some embodiments, the electrostatic atomizer 10 of can be configured such that the internal solvent line 55 diverges from the solvent fluid line 51 downstream of a mounting member 60.

According to multiple embodiments, the electrostatic atomizer 10 can be configured such that the applicator 20 is a bell cup 20 comprising a splash plate 130.

In some embodiments, the electrostatic atomizer 10 can be configured such that the fluid path deflector comprises a splash plate inner surface 131 and splash plate outer surface 132.

In certain embodiments, the electrostatic atomizer 10 can be configured such that the internal solvent line 55 is configured to dispense cleaning solvent upstream and downstream of the fluid path deflector inner surface.

According to multiple embodiments, the electrostatic atomizer 10 can be configured such that cleaning solvent from the internal solvent line 55 is configured to pass over the internal applicator surface 54, the fluid path deflector inner surface, and the fluid path deflector outer surface by rotary motion of the bell cup 20.

As shown in FIG. 2, according to multiple embodiments, a method of cleaning an applicator 20 of an electrostatic atomizer 10, can comprise providing the electrostatic atomizer 10 of the embodiments herein; and passing cleaning solvent through the cup washing component.

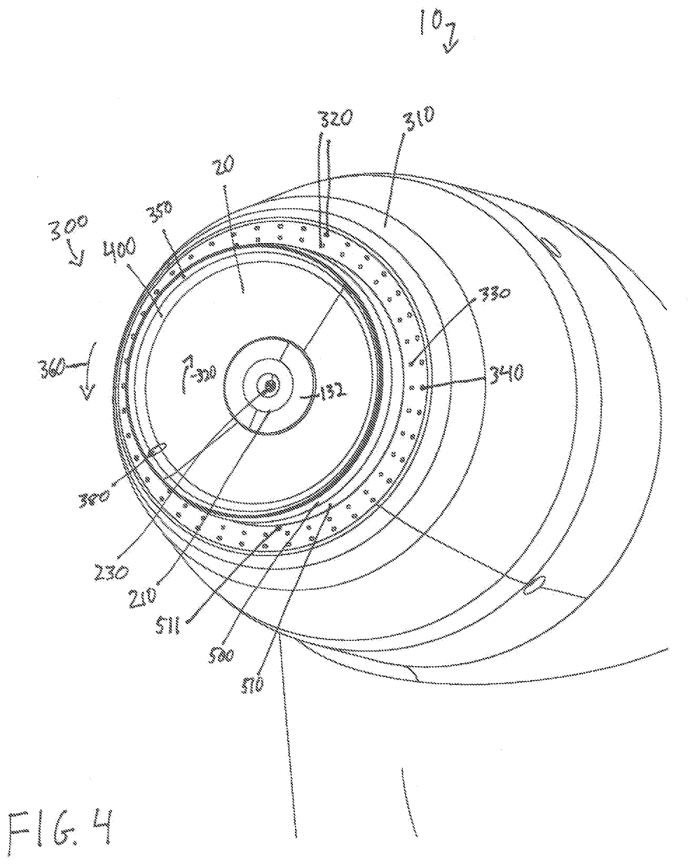

As shown in FIGS. 3-4, in some embodiments, the electrostatic atomizer 10 can include a shaping air shroud 310, wherein the smooth inner surface 400 is adjacent to an expansion area 511, wherein the expansion area 511 is configured to reduce a Reynold's Number of an air flow around the edge of the applicator 20.

In some embodiments, the electrostatic atomizer 10 can include a shaping air shroud 310, wherein the expansion area 511 is partially defined by a flat front wall 500 of the atomizer shroud. In certain embodiments, the electrostatic atomizer 10 can include a shaping air shroud 310, wherein the expansion area 511 is partially defined by an angled edge 350 of the applicator 20. In some embodiments, the electrostatic atomizer 10 can include a shaping air shroud 310, wherein the expansion area 511 is partially defined by a lower extension wall 510 of the atomizer shroud. According to multiple embodiments, the electrostatic atomizer 10 can include a shaping air shroud 310, wherein the lower extension wall 510 is adjacent to the flat front wall 500.

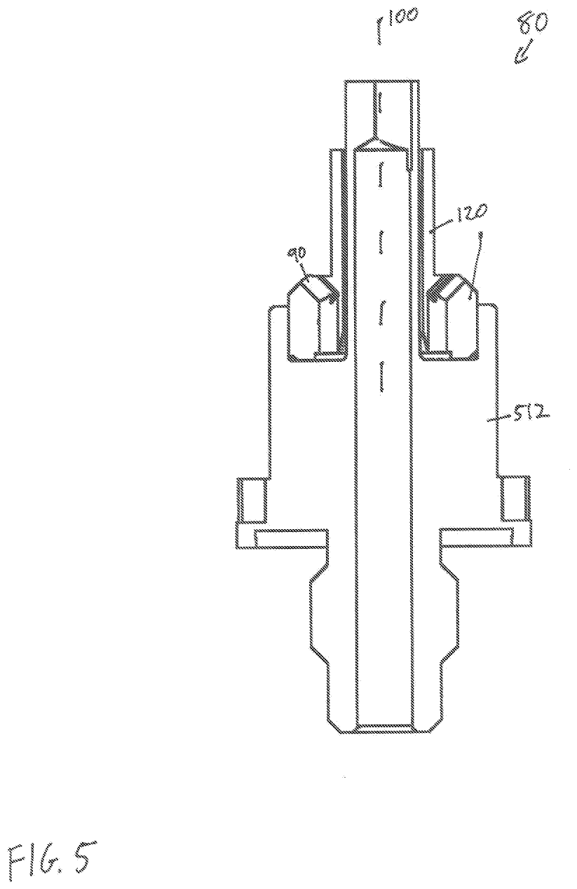

As shown in FIG. 5, in certain embodiments, an electrostatic atomizer 10 can be configured such that a fluid tip 80 further includes a fluid tip insert component 120 radially circumscribing the external cup wash outlets 90 and wherein the fluid tip insert component 120 is configured to fit into a splash plate 130.

In some embodiments, an electrostatic atomizer 10 can be configured such that the fluid tip 80 includes a notched surface, wherein the fluid tip 80 external cup wash outlets 90 are configured to deliver solvent through a portion of the notched surface.

According to multiple embodiments, the electrostatic atomizer 10 can be configured such that the bell cup 20 threaded surface 260 is configured to receive and secure a splash plate 130 by a threaded connection.

In certain embodiments, the electrostatic atomizer 10 can be configured such that wherein the external cup wash groove 140 is configured to receive solvent from a plurality of external cup wash outlets 90.

In some embodiments, the electrostatic atomizer 10 can be configured such that a plurality of holes exit the splash plate 130 at an angle 450 between 40 and 45 degrees relative to a splash plate center axis 240.

### Embodiments

In a first embodiment, provided is an electrostatic atomizer comprising: an applicator rotatably attached to a distal end of a turbine and a shaft; and an applicator washing component comprising a solvent fluid line configured to separately dispense a cleaning solvent to an external applicator surface by an external solvent line and an internal applicator surface by an internal solvent line, wherein the cup washing component is distinct from a coating fluid line.

The first embodiment or any previous or subsequent embodiments can provide that the external solvent line diverges from the solvent fluid line upstream of a mounting member.

The first embodiment or any previous or subsequent embodiments can provide that the external solvent line diverges from the solvent fluid line within a fluid tip.

The first embodiment or any previous or subsequent embodiments can provide that the external solvent line diverges to a plurality of external cup wash outlets, wherein the plurality of external cup wash outlets are radially evenly spaced about a fluid tip center axis.

The first embodiment or any previous or subsequent embodiments can provide that the plurality of external cup wash outlets are at between a 40 degree and a 50 degree angle relative to the fluid tip center axis.

The first embodiment or any previous or subsequent embodiments can provide that the fluid tip further comprises a fluid tip insert component radially circumscribing the external cup wash outlets and wherein the fluid tip insert component is configured to fit into a splash plate 130.

The first embodiment or any previous or subsequent embodiments can provide that the applicator is a bell cup, wherein the bell cup comprises: an external cup wash groove circumscribing the bell cup around a cup base; an internal cup wash groove circumscribing a bell cup center axis axially behind the cup base; and a threaded surface axially between the external cup wash groove and internal cup wash groove.

The first embodiment or any previous or subsequent embodiments can provide that the bell cup further comprises a splash plate hardstop 200 axially between the threaded surface and external cup wash groove.

The first embodiment or any previous or subsequent embodiments can provide that the threaded surface and splash plate hardstop 200 are radially centered about a bell cup center axis.

The first embodiment or any previous or subsequent embodiments may further provide for further comprising a splash plate system 210, wherein the splash plate system 210 comprises: a splash plate base 220; and a splash plate 130 comprising a plurality of splash plate holes 230 radially evenly spaced about a splash plate center axis 240.

The first embodiment or any previous or subsequent embodiments can provide that the splash plate base 220 comprises a threaded portion configured to threadedly connect to a bell cup threaded surface.

The first embodiment or any previous or subsequent embodiments can provide that the splash plate base 220 comprises a splash plate base 220 protrusion configured to fit within a splash plate 130 notch, and wherein the splash plate base 220 is fixed to the splash plate 130 by a plurality of pins.

The first embodiment or any previous or subsequent embodiments may further provide for further comprising a shaping air system for a coating atomizer, wherein the shaping air system comprises: a shroud, wherein the shroud comprises a plurality of concentric rings of holes, wherein a first concentric ring is configured to direct shaping air toward an edge of an applicator, and wherein a second concentric ring is configured to direct shaping air away from the edge of the applicator, and wherein the plurality of concentric rings are configured to generate a shaping air spin against a direction of rotation of the applicator.

The first embodiment or any previous or subsequent embodiments may further provide for further comprising a lower shaping air component, wherein the lower shaping air component is configured to limit negative pressure region sizes behind the applicator, wherein the lower shaping air component comprises a smooth inner surface substantially parallel to an inner surface of the applicator.

The first embodiment or any previous or subsequent embodiments may further provide for comprising: a high voltage supply; a grounded robot manifold plate; and a coiled tube, wherein the coiled tube segregates the high voltage supply from the robot manifold plate, wherein the coiled tube is in fluid communication with a solvent source.

In a second embodiment, provided is an electrostatic atomizer wherein the solvent source is configured to clean the applicator by diverging to an internal solvent line and an external solvent line.

The second embodiment or any previous or subsequent embodiments can further provide for further comprising a paint inlet isolation tube, wherein the coiled tube is wrapped around the paint inlet isolation tube.

The second embodiment or any previous or subsequent embodiments can can provide that the coiled tube comprises a perfluoroalkoxy alkane polymer.

The second embodiment or any previous or subsequent embodiments can can provide that the coiled tube consists of a perfluoroalkoxy alkane polymer within an outer nylon tube.

In a third embodiment, provided is an electrostatic atomizer wherein the external solvent line passes through an external solvent line cavity in the fluid tip, wherein the external solvent line cavity is upstream of the mounting member.

The third embodiment or any previous or subsequent embodiments can provide that the applicator comprises an applicator cavity.

The third embodiment or any previous or subsequent embodiments can provide that the applicator comprises a plurality of applicator holes.

The third embodiment or any previous or subsequent embodiments can provide that the external solvent line is configured to feed cleaning solvent into the applicator cavity.

The third embodiment or any previous or subsequent embodiments can provide that the cleaning solvent is configured to move from the applicator cavity to the external surface of the applicator through the plurality of holes.

The third embodiment or any previous or subsequent embodiments can further provide for The electrostatic atomizer of claim 1, wherein the internal solvent line diverges from the solvent fluid line downstream of a mounting member.

The third embodiment or any previous or subsequent embodiments can provide that the applicator is a bell cup comprising a splash plate 130.

The third embodiment or any previous or subsequent embodiments can provide that the fluid path deflector comprises a splash plate 130 inner surface and splash plate 130 outer surface.

The third embodiment or any previous or subsequent embodiments can provide that the internal solvent line is configured to dispense cleaning solvent upstream and downstream of the fluid path deflector inner surface.

The third embodiment or any previous or subsequent embodiments can provide that cleaning solvent from the internal solvent line is configured to pass over the internal applicator surface, the fluid path deflector inner surface, and the fluid path deflector outer surface by rotary motion of the bell cup.

In fourth embodiment, provided is a method of cleaning an applicator of an electrostatic atomizer, comprising: providing the electrostatic atomizer of the embodiments herein; and passing cleaning solvent through the cup washing component.

In a fifth embodiment provided is an electrostatic atomizer comprising a shaping air shroud, wherein the smooth inner surface is adjacent to an expansion area, wherein the expansion area is configured to reduce a Reynold's Number of an air flow around the edge of the applicator.

The fifth embodiment or any previous or subsequent embodiments can further provide for comprising a shaping air shroud, wherein the expansion area is partially defined by a flat front wall of the atomizer shroud.

The fifth embodiment or any previous or subsequent embodiments can further provide for comprising a shaping air shroud, wherein the expansion area is partially defined by an angled edge of the applicator.

The fifth embodiment or any previous or subsequent embodiments can further provide for comprising a shaping air shroud, wherein the expansion area is partially defined by a lower extension wall of the atomizer shroud.

The fifth embodiment or any previous or subsequent embodiments can further provide for comprising a shaping air shroud, wherein the lower extension wall is adjacent to the flat front wall.

In a sixth embodiment provided is a fluid tip wherein the fluid tip further comprises a fluid tip insert component radially circumscribing the external cup wash outlets and wherein the fluid tip insert component is configured to fit into a splash plate 130.

The sixth embodiment or any previous or subsequent embodiments can further include a notched surface, wherein the fluid tip external cup wash outlets are configured to deliver solvent through a portion of the notched surface.

In a seventh embodiment, provided is a bell cup wherein a threaded surface is configured to receive and secure a splash plate 130 by a threaded connection.

The seventh or any previous or subsequent embodiments can provide that the external cup wash groove is configured to receive solvent from a plurality of external cup wash outlets.

In an eighth embodiment, provided is a splash plate system 210 wherein the plurality of holes exit the splash plate 130 at an angle between 40 and 45 degrees relative to a splash plate center axis 240.

What has been described above include mere examples of electrostatic atomizers, components, and methods. It is, of course, not possible to describe every conceivable combination of components and methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. An electrostatic atomizer comprising:
an applicator rotatably attached to a distal end of a turbine and a shaft; and
an applicator washing component comprising a solvent fluid line configured to separately dispense a cleaning solvent to an external applicator surface by an external solvent line and an internal applicator surface by an internal solvent line, wherein the cup washing component is distinct from a coating fluid line.

2. The electrostatic atomizer of claim 1, wherein the external solvent line diverges from the solvent fluid line upstream of a mounting member.

3. The electrostatic atomizer of claim 2, wherein the external solvent line diverges from the solvent fluid line within a fluid tip.

4. The electrostatic atomizer claim 1, wherein the external solvent line diverges to a plurality of external cup wash outlets, wherein the plurality of external cup wash outlets are radially evenly spaced about a fluid tip center axis.

5. The electrostatic atomizer claim 4, wherein the plurality of external cup wash outlets are at between a 40 degree and a 50 degree angle relative to the fluid tip center axis.

6. The electrostatic atomizer claim 4, wherein the fluid tip further comprises a fluid tip insert component radially circumscribing the external cup wash outlets and wherein the fluid tip insert component is configured to fit into a splash plate.

7. The electrostatic atomizer of claim 1, wherein the applicator is a bell cup, wherein the bell cup comprises: an external cup wash groove circumscribing the bell cup around a cup base; an internal cup wash groove circumscribing a bell cup center axis axially behind the cup base; and a threaded surface axially between the external cup wash groove and internal cup wash groove.

8. The electrostatic atomizer of claim 7, wherein the bell cup further comprises a splash plate hardstop axially between the threaded surface and external cup wash groove.

9. The electrostatic atomizer of claim 8, wherein the threaded surface and splash plate hardstop are radially centered about a bell cup center axis.

10. The electrostatic atomizer of claim 1 further comprising a splash plate system, wherein the splash plate system comprises:
a splash plate base; and
a splash plate comprising a plurality of splash plate holes radially evenly spaced about a splash plate center axis.

11. The electrostatic atomizer of claim 10, wherein the splash plate base comprises a threaded portion configured to threadedly connect to a bell cup threaded surface.

12. The electrostatic atomizer of claim 10, wherein the splash plate base comprises a splash plate base protrusion configured to fit within a splash plate notch, and wherein the splash plate base is fixed to the splash plate by a plurality of pins.

13. The electrostatic atomizer of claim 1, further comprising a shaping air system, wherein the shaping air system comprises:
a shroud, wherein the shroud comprises a plurality of concentric rings of holes, wherein a first concentric ring is configured to direct shaping air toward an edge of an applicator, and wherein a second concentric ring is configured to direct shaping air away from the edge of the applicator, and wherein the plurality of concentric rings are configured to generate a shaping air spin against a direction of rotation of the applicator.

14. The electrostatic atomizer of claim 13, further comprising a lower shaping air component, wherein the lower shaping air component is configured to limit negative pressure region sizes behind the applicator, wherein the lower shaping air component comprises a smooth inner surface substantially parallel to an inner surface of the applicator.

15. The electrostatic atomizer of claim 1, further comprising:
a high voltage supply;
a grounded robot manifold plate; and
a coiled tube, wherein the coiled tube segregates the high voltage supply from the robot manifold plate, wherein the coiled tube is in fluid communication with a solvent source.
